(19) United States
(12) Patent Application Publication
(10) Pub. No.: US 2026/0172256 A1
(43) Pub. Date: Jun. 18, 2026

(54) TECHNIQUES FOR ENSURING BIOMETRIC INPUT FRESHNESS

(71) Applicant: QUALCOMM Incorporated, San Diego, CA (US)

(72) Inventors: Jerome PERRINE, Romanel sur Morges (CH); Pierre-Francois APPIETTO, Châteauneuf-le-Rouge (FR)

(21) Appl. No.: 18/986,651

(22) Filed: Dec. 18, 2024

(51) Int. Cl. H04L 9/32; H04L 9/06

(52) U.S. Cl. CPC H04L 9/3231; H04L 9/0643

(57) ABSTRACT

Systems and techniques are provided for security. For instance, a process can include receiving, by a first process executing in a trusted execution environment, sensor information from a sensor based on an acquisition request transmitted to the sensor; processing, by the first process, the sensor information to generate a first hash of the sensor information; transmitting the first hash of the sensor information to a second process executing in a secure execution environment separate from the trusted execution environment for comparison with a second hash of the sensor information from the sensor; and receiving, from the second process, an indication that the first hash matches the second hash.

### FIELD

The present disclosure generally relates to secure computing. For example, aspects of the present disclosure relate to systems and techniques for ensuring biometric input freshness for securing biometric information.

### BACKGROUND

Object authentication and/or verification can be used to authenticate or verify an object. For example, biometric-based authentication methods exist for authenticating people. Biometric-based authentication can be used for various purposes, such as providing access to places and/or electronic devices. Examples of biometric-based authentication include face authentication, fingerprint authentication, voice authentication, among others.

Face authentication, for example, can compare a face of a device user in an input image with known features of the person the user claims to be, in order to authenticate that the user of the device is, in fact, the person. A similar process can be performed for fingerprint authentication, voice authentication, and other biometric-based authentication methods.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Disclosed are systems, methods, apparatuses, and computer-readable media for performing delegated attestation. In one illustrative example, an apparatus for security is provided. The apparatus includes a memory system comprising instructions and a processor system coupled to the memory system. The processor system is configured to: receive, by a first process executing in a trusted execution environment, sensor information from a sensor based on an acquisition request transmitted to the sensor; process, by the first process, the sensor information to generate a first hash of the sensor information; transmit the first hash of the sensor information to a second process executing in a secure execution environment separate from the trusted execution environment for comparison with a second hash of the sensor information from the sensor; and receive, from the second process, an indication that the first hash matches the second hash.

As another example, a method for security is provided. The method includes: receiving, by a first process executing in a trusted execution environment, sensor information from a sensor based on an acquisition request transmitted to the sensor; processing, by the first process, the sensor information to generate a first hash of the sensor information; transmitting the first hash of the sensor information to a second process executing in a secure execution environment separate from the trusted execution environment for comparison with a second hash of the sensor information from the sensor; and receiving, from the second process, an indication that the first hash matches the second hash.

In another example, a non-transitory computer-readable medium having stored thereon instructions is provided. The instruction, when executed by at least one processor, cause the at least one processor to: receive, by a first process executing in a trusted execution environment, sensor information from a sensor based on an acquisition request transmitted to the sensor; process, by the first process, the sensor information to generate a first hash of the sensor information; transmit the first hash of the sensor information to a second process executing in a secure execution environment separate from the trusted execution environment for comparison with a second hash of the sensor information from the sensor; and receive, from the second process, an indication that the first hash matches the second hash.

As another example, an apparatus for security is provided. The apparatus includes: means for receiving, by a first process executing in a trusted execution environment, sensor information from a sensor based on an acquisition request transmitted to the sensor; means for processing, by the first process, the sensor information to generate a first hash of the sensor information; means for transmitting the first hash of the sensor information to a second process executing in a secure execution environment separate from the trusted execution environment for comparison with a second hash of the sensor information from the sensor; and means for receiving, from the second process, an indication that the first hash matches the second hash.

In some aspects, one or more of the apparatuses described herein is, is a part of, or includes a mobile device (e.g., a mobile telephone or so-called “smart phone”, a tablet computer, or other type of mobile device), a wearable device, an extended reality device (e.g., a virtual reality (VR) device, an augmented reality (AR) device, or a mixed reality (MR) device), a personal computer, a laptop computer, a video server, a television (e.g., a network-connected television), a vehicle (or a computing device or system of a vehicle), or other device. In some aspects, the apparatus includes at least one camera for capturing one or more images or video frames. For example, the apparatus can include a camera (e.g., an RGB camera) or multiple cameras for capturing one or more images and/or one or more videos including video frames. In some aspects, the apparatus includes a display for displaying one or more images, videos, notifications, or other displayable data. In some aspects, the apparatus includes a transmitter configured to transmit one or more video frame and/or syntax data over a transmission medium to at least one device. In some aspects, the processor includes a neural processing unit (NPU), a central processing unit (CPU), a graphics processing unit (GPU), or other processing device or component.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware elements including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

Other objects and advantages associated with the aspects disclosed herein will be apparent to those skilled in the art based on the accompanying drawings and detailed description.

### BRIEF DESCRIPTION OF THE DRAWINGS

Examples of various implementations are described in detail below with reference to the following figures:

FIG. 1 is a diagram illustrating an example wireless device, in accordance with some examples;

FIG. 2 is a flowchart illustrating an example of a general authentication process using a face as biometric data;

FIG. 3 is a diagram illustrating signals and operations for a secure pairing process for ensuring biometric input freshness, in accordance with aspects of the present disclosure;

FIG. 4 is a diagram illustrating signals and operations for an acquisition request process for ensuring biometric input freshness, in accordance with aspects of the present disclosure;

FIG. 5 is a flow diagram of a process for security, in accordance with aspects of the present disclosure; and

FIG. 6 is a diagram illustrating an example of a computing system, according to aspects of the disclosure.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides example embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the application as set forth in the appended claims.

Biometrics is the science of analyzing physical or behavioral characteristics specific to each individual, in order to be able to authenticate the identity of each individual. Biometric-based authentication methods can be used to authenticate people, such as to provide access to devices, systems, places, or other accessible items. In some cases, biometric-based authentication allows a person to be authenticated based on a set of templates (verifiable data), which are unique to the person. Examples of biometric-based authentication include face authentication, fingerprint authentication, voice authentication, among others. Face authentication, for example, can compare a face of a device user in an input image with known features (e.g., stored in one or more templates) of the person the user claims to be, in order to authenticate that the user of the device is, in fact, the person. A similar process can be performed for fingerprint authentication, voice authentication, and other biometric-based authentication methods.

Biometric-based user authentication systems typically have at least two steps, including an enrollment step and an authentication step (or test step). The enrollment step captures biometric data (e.g., biometric information) and stores representations of the biometric data as a biometric template (e.g., template). The biometric template may be a representation of biometric data for a person that can be stored and matched against to authenticate the person. The template can then be used in the authentication step. For example, the authentication step can determine the similarity of the template against a representation of input biometric data (also referred to as user credentials). The authentication step can use the similarity to determine whether to authenticate the user.

In some cases, biometric systems may be used to authenticate or verify a person, for example, to allow access to a device, area, and/or application. Using face authentication as an example, an input query face image can be compared with stored or enrolled representations of a person's face to determine whether to allow the person access to a device.

In some cases, a device may perform biometric processing (e.g., for a biometric system) using a biometric process execution environment (BPEE). The BPEE may be a process executing in a trusted execution environment (TEE) of the device. The TEE may be secure area of, for example, a processor that can be used to process and/or store sensitive data in an environment that is segregated from a rich execution environment in which a primary operating system (e.g., user facing operating systems such as Android, iOS, Windows, etc.) and/or applications may be executed. However, the BPEE may be vulnerable to certain types of attacks. In some cases, techniques for detecting certain attacks, such as data replay or injection attacks may be useful.

Systems, apparatuses, electronic devices, methods (also referred to as processes), and computer-readable media (collectively referred to herein as “systems and techniques”) are described herein for ensuring biometric input freshness for securing biometric information. A secure execution environment may be an isolated processing environment for executing code and the secure execution environment may limit access to certain resources of the device, for example, to maintain security. In contrast, a rich execution environment may be a processing environment for executing code which has access to substantially all of the resources of the devices. In some cases, devices may include a high assurance execution environment (HAEE). This HAEE may be a secure execution environment separate from the TEE and the HAEE may include an added layers of hardware security as compared to the TEE. The HAEE may be separate from the TEE in that the HAEE may include a processing environment that is isolated from the TEE and the rich execution environment. The HAEE may provide increased security as compared to the TEE. For example, the HAEE may be evaluation assurance level (EAL) 5+ and assurance vulnerability analysis level 5 (AVA_VAN.5) certified, while the TEE may be EAL 2+.

In some cases, the HAEE may be used to enhance security of biometric processing. For example, a first process (e.g., BPEE) executing in a TEE may receive sensor information from a sensor based on an acquisition request indicating to the sensor to sense the environment transmitted to the sensor. For example, an application executing in a rich execution environment (REE) may send a request to a BPEE requesting biometric information be acquired from a person. The REE may be a primary operating system (e.g., user facing operating systems such as Android, iOS, Windows, etc.) and/or applications may be executed. The BPEE may transmit an acquisition request to a sensor, such as a biometric sensor. While examples described herein are with respect to biometric sensors such as fingerprint, iris, palm, and face detecting sensors, the systems and techniques discussed here may be applicable to any sensor and/or chip for acquiring data. The sensor and/or chip does not need to process the acquired data in some cases. The sensor and/or chip should have some computational capabilities, such as a capability to compute hashes. As an examples, the sensor may acquire the biometric information. The sensor may transmit non-hashed biometric information to the BPEE. The BPEE may hash the sensor information to generate a first hash of the sensor information. The BPEE may send the first hash of the sensor information to the HAEE. The sensor may hash the biometric information using an ephemeral key obtained from the HAEE to generate a second hash of the sensor information. The sensor may transmit the second hash to the HAEE. The HAEE may verify that the first hash matches the second hash to confirm that the sensor and the BPEE (and data) have not been tampered with. The HAEE may transmit an indication that the hashes match to the BPEE and the BPEE may process the biometric information, for example, by attempting to authenticate the person using the biometric information.

In some aspects, one or more of the apparatuses described herein comprises a mobile device (e.g., a mobile telephone or so-called “smart phone”, a tablet computer, or other type of mobile device), a wearable device, an extended reality device (e.g., a virtual reality (VR) device, an augmented reality (AR) device, or a mixed reality (MR) device), a personal computer, a laptop computer, a video server, a television (e.g., a network-connected television), a vehicle (or a computing device of a vehicle), or other device. In some aspects, the apparatus(es) includes at least one camera for capturing one or more images or video frames. For example, the apparatus(es) can include a camera (e.g., an RGB camera) or multiple cameras for capturing one or more images and/or one or more videos including video frames. In some aspects, the apparatus(es) includes at least one display for displaying one or more images, videos, notifications, or other displayable data. In some aspects, the apparatus(es) includes at least one transmitter configured to transmit one or more video frame and/or syntax data over a transmission medium to at least one device. In some aspects, the at least one processor includes a neural processing unit (NPU), a neural signal processor (NSP), a central processing unit (CPU), a graphics processing unit (GPU), any combination thereof, and/or other processing device or component.

Additional aspects of the present disclosure are described in more detail below.

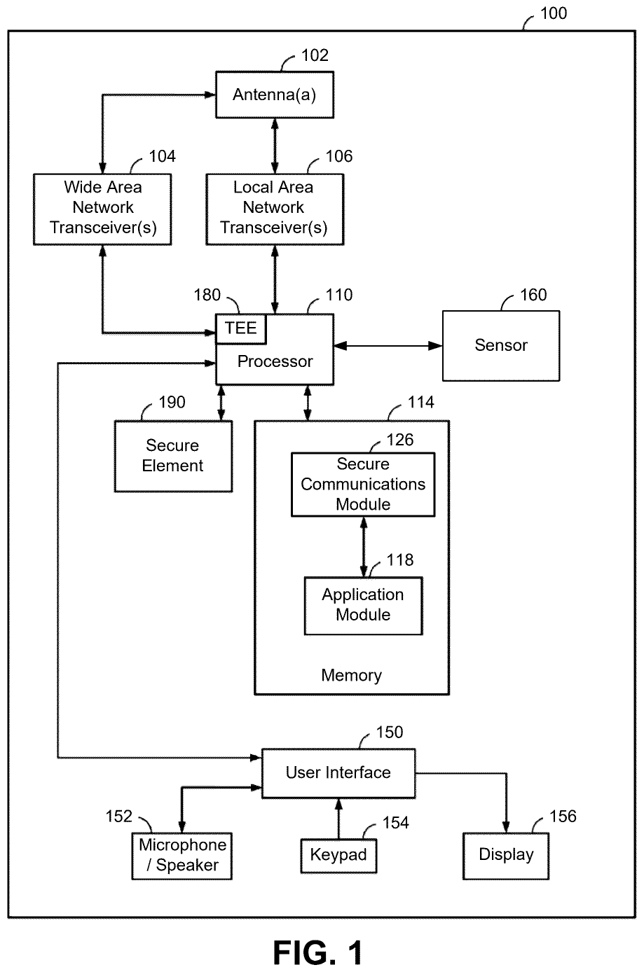

FIG. 1 is a diagram illustrating an example wireless device 100 that can be used to perform the techniques described herein. The wireless device 100 may include a client device such as a user equipment (UE) or other type of device (e.g., a station (STA) configured to communication using a Wi-Fi interface) that may be used by an end-user. For example, the wireless device 100 may include a mobile phone, a vehicle or computing system or device of the vehicle, a router, a tablet computer, a laptop computer, a tracking device, a wearable device (e.g., a smart watch, glasses, etc.), an extended reality (XR) device (e.g., a virtual reality (VR), augmented reality (AR), or mixed reality (MR) device, etc.), an Internet of Things (IoT) device, a access point, a point of sale device, and/or another device that is configured to communicate over a wireless communications network.

As shown, the wireless device 100 may include one or more local area network transceivers 106 that may be connected to one or more antennas 102. The one or more local area network transceivers 106 comprise suitable devices, circuits, hardware, and/or software for communicating with and/or detecting signals to/from a network device, and/or directly with other wireless devices, within a network.

The wireless device 100 may also include, in some implementations, one or more wide area network transceiver(s) 104 that may be connected to the one or more antennas 102. The wide area network transceiver 104 may comprise suitable devices, circuits, hardware, and/or software for communicating with and/or detecting signals from one or more other devices or systems and/or directly with other wireless devices within a network. In some implementations, the wide area network transceiver(s) 104 may comprise a CDMA communication system suitable for communicating with a CDMA network of wireless base stations. In some implementations, the wireless communication system may comprise other types of cellular telephony networks, such as, for example, TDMA, GSM, WCDMA, LTE, NR, and the like. Additionally, any other type of wireless networking technologies may be used, including, for example, WiMax (802.16), Wi-Fi (802.11), and the like.

The processor(s) (also referred to as a controller) 110 may be connected to the local area network transceiver(s) 106 and the wide area network transceiver(s) 104. The processor 110 may include one or more microprocessors, microcontrollers, and/or digital signal processors that provide processing functions, as well as other calculation and control functionality. The processor 110 may be coupled to storage media (e.g., memory) 114 for storing data and software instructions for executing programmed functionality within the mobile device. The memory 114 may be on-board the processor 110 (e.g., within the same IC package), and/or the memory may be external memory to the processor and functionally coupled over a data bus.

In some cases, the processor 110 may be coupled to a location sensor 160. The location sensor 160 may provide information regarding a location of the wireless device 100. In some cases, the location sensor 160 may include a Global Navigation Satellite System (GNSS) receivers or transceivers that are used to determine a location of the wireless device 100. In some cases, the location sensor 160 may estimate a location of the wireless device 100, for example, based on wireless signals received from one or more wireless nodes.

A number of software engines and data tables may reside in memory 114 and may be utilized by the processor 110 in order to manage both communications with remote devices/nodes, perform positioning determination functionality, and/or perform device control functionality. In some embodiments, the memory 114 may include an application engine 118 and a secure communications engine 126. It is to be noted that the functionality of the modules and/or data structures may be combined, separated, and/or be structured in different ways depending upon the implementation of the wireless device 100.

The application engine 118 may include a process running on the processor 110 of the wireless device 100, which may request data from one of the other modules of the wireless device 100. Applications typically run within an upper layer of the software architectures and may be implemented in a rich execution environment of the wireless device 100, and may include indoor navigation applications, shopping applications, financial services applications, social media applications, location aware service applications, etc. The applications of the application engine 118 may make use of access tokens to obtain content from a remote server.

The secure communications engine 126 may be a process configured to manage the storage of and access to the access tokens, encryption keys, attestation information, and the like. The secure communications engine 126 may be executed on a processor component of a trusted execution environment (TEE 180) and/or the secure element 190, where the wireless device 100 includes such components. The functionality of the secure communications engine 126 discussed herein can also be implemented as hardware or a combination of hardware and software. The secure communications engine 126 can be implemented one or more application specific integrated circuits (ASICs), programmable logic devices (PLDs), field programmable gate arrays (FPGAs), or other electronic units designed to perform the functions described herein, or a combination thereof.

The wireless device 100 may further include a user interface 150 providing suitable interface systems, such as a microphone/speaker 152, a keypad 154, and a display 156 that allows user interaction with the wireless device 100. The microphone/speaker 152 provides for voice communication services (e.g., using the wide area network transceiver(s) 104 and/or the local area network transceiver(s) 106). The keypad 154 may comprise suitable buttons for user input. The display 156 may include a suitable display, such as, for example, a backlit LCD display, and may further include a touch screen display for additional user input modes.

The processor 110 may also include a TEE 180. The TEE 180 can be implemented as a secure area of the processor 110 that can be used to process and store sensitive data in an environment that is segregated from the rich execution environment in which the operating system and/or applications (such as those of the application engine 118) may be executed. An example of a TEE may include an ARM TrustZone execution environment, which may execute authorized software known as “trusted application.” The TEE 180 can be configured to execute trusted applications that provide end-to-end security for sensitive data by enforcing confidentiality, integrity, and protection of the sensitive data stored therein. The TEE 180 can be used to store encryption keys, access tokens, and other sensitive data. In some cases, the TEE 180 may also be able to attest to the integrity of certain software executing on the wireless device 100. As used herein attestation is a process by which software executing on the wireless device 100 provides an assertion (e.g., information) to a relying party about the integrity of the wireless device 100. Examples for the assertion may include a hash of the application, a measurement of an operating system kernel, cryptographic function, security software, etc.

The wireless device 100 may include a secure element 190 (also referred to herein as a trusted component). The wireless device 100 may include the secure element 190 in addition to or instead of the TEE 180. The secure element 190 may be considered more secure (protected by more security features) as compared to the TEE 180. The secure element 190 can comprise autonomous and tamper-resistant hardware that can be used to execute secure applications and the confidential data associated with such applications. For example, the secure element 190 may include a high assurance execution environment (HAEE) (e.g., secure processing unit), which may include added layers of hardware security as compared to the TEE 180. The secure element 190 may be a secure execution environment separate from the TEE 180 and the secure element 190 may include more limited computing resources as compared to the TEE 180. The secure element 190 can be used to store encryption keys, access tokens, and other sensitive data. The secure element 190 can comprise a Near Field Communication (NFC) tag, a Subscriber Identity Module (SIM) card, or other type of hardware device that can be used to securely store data. The secure element 190 can be integrated with the hardware of the wireless device 100 in a permanent or semi-permanent fashion or may, in some implementations, be a removable or external component of the wireless device 100 that can be used to securely store data and/or provide a secure execution environment for applications.

In some cases, to help reduce an attack surface against side-channel attacks, some secure applications may execute in a secure processing unit, such as the TEE 180 and/or secure element 190, without knowledge of other components in their operating environment, such as the wide/local area networks, sensors, such as the sensor 160, and/or certain elements of the user interface, such as the microphone/speaker 152. In some cases, the sensor 160 may include some computational capability, such as to determine hashes or perform cryptographic operations. In some cases, certain elements, such as the keypad 154 and/or display 156, may be needed by a secure application, for example, to provide a password to use a key to encrypt/decrypt data.

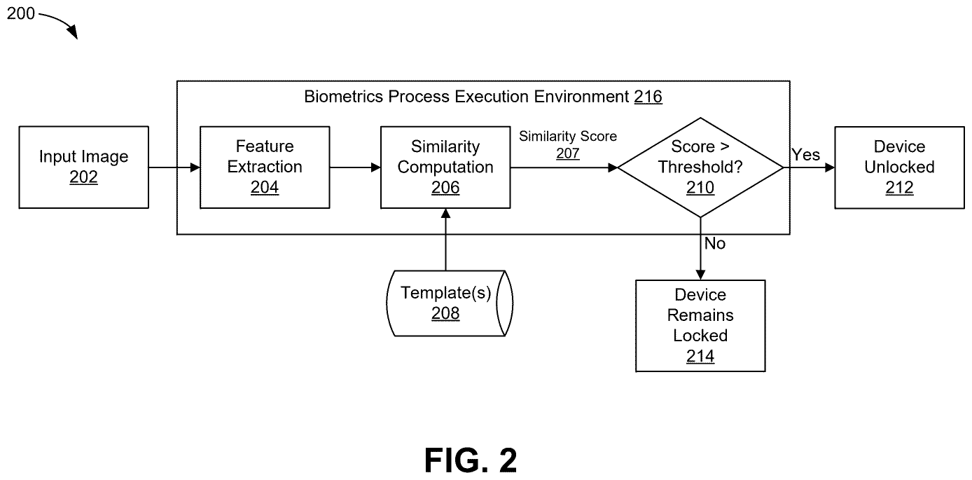

FIG. 2 is a flowchart illustrating an example of a general authentication process 200 using a face as biometric data. As an example, a biometric data 202 of a user attempting to access a device is received. For example, the biometric data 202 can be an image captured by a camera of a wireless device. In some cases, a face detection engine (not shown) can be used to identify the face in the biometric data 202. Of note, while discussed in the context of using a face as biometric data, it should be understood that the general authentication process 200 may be applied to the use of other types of biometric data as well, such as fingerprint identification, palm authentication, iris authentication, etc. In some cases, the biometric data 202 may be another type of biometric information suitable for another type of biometric authentication. For example, for fingerprint authentication, the biometric data 202 may instead be information about a fingerprint.

The biometric data 202 may be processed for feature extraction 204. For example, a feature representation including one or more features of the face can be extracted by a feature extraction engine (not shown) from the biometric data 202 containing the face. In some examples, a cropped portion of the biometric data 202 including the image data within the bounding region identified by the face detection engine is processed for feature extraction. The feature representation of the face can be compared to a face representation (e.g., stored as a biometric template in template storage 208, which may be in a memory of the device) of a person authorized to access the device. In some examples, the template storage 208 can include a database. In some examples, the template storage 208 is part of the same device that is performing biometric authentication (e.g., wireless device 100). As used herein, a biometric template, or template, may be a representation of a biometric feature of a person, such as a representation of the person's face, fingerprint, hand print, iris, finger blood flow patterns, etc.

The biometric templates in the template storage 208 can be generated during an enrollment step (e.g., enrollment procedure), when a person is registering their biometric features for later use during authentication. Each template can be linked internally (e.g., in the template storage 208) to a subject identifier (ID) that is unique to the person being registered. For example, during enrollment (which can also be referred to as registration), an owner of the computing device and/or other user with access to the computing device can input one or more biometric data samples (e.g., an image, a fingerprint sample, a voice sample, or other biometric data). Representative features of the biometric data can be extracted by the feature extraction engine. The representative features of the biometric data can be stored as one or more templates in the template storage 208. For instance, several images can be captured of the owner or user with different poses, positions, facial expressions, lighting conditions, fingers, eyes, palms, and/or other characteristics. Facial features of the different images can be extracted and saved as templates. For instance, a template can be stored for each image, with each template representing the features of each face with its unique pose, position, facial expression, lighting condition, etc. The one or more templates stored in the template storage 208 can be used as a reference point for performing face authentication.

As noted above, the feature extraction engine (not shown) extracts features from the biometric data 202. Any suitable feature extraction technique can be used by the feature extraction engine to extract features from the biometric data (during registration and during the authentication). Various examples of feature extraction techniques that can be used by the feature extraction engine are described in Wang, et al., “Face Feature Extraction: A Complete Review,” IEEE Access, Volume 6, 2018, Pages 6001-6039, which is hereby incorporated by reference in its entirety and for all purposes. One illustrative example of a feature extraction process performed by the feature extraction engine that can generate deep learning features is neural network (e.g., using a deep learning network) based feature extraction. For example, a neural network can be trained using multiple training images to learn distinctive features of various face. Once trained, the trained neural network can then be applied to the biometric data 202. For example, the trained neural network can extract or determine distinctive features of the face.

In some cases, a similarity computation 206 can be made between the feature representation of the user extracted from the biometric data 202 and a feature representation of a template stored in the template storage 208. For example, a representation of the features extracted from the biometric data 202 can be compared to the one or more templates stored in the template storage 208 by a similarity determination engine (not shown). For example, the process 200 can perform a similarity computation 206 to compute the similarity between the biometric data 202 and the one or more templates in the template storage 208. The computed similarity can be used as the similarity score 207 that will be used to make the final authentication decision.

In some cases, the data of the biometric data 202 can also be referred to as query data (e.g., a query face, query fingerprint, etc.). In some cases, the templates can also be referred to as enrolled data (e.g., an enrolled face, enrolled finger, etc.). As noted above, in some examples, the features extracted for a face (or other object or biometric feature) can be represented using a feature vector that represents the face (or other object or biometric feature). For instance, each template can be a feature vector. The representation of the features extracted from the input biometric data can also be a feature vector. Each feature vector can include a number of values representing the extracted features. The values of a feature vector can include any suitable values. In some cases, the values of a feature vector can be floating numbers between −1 and 1, which are normalized feature vector values. The feature vector representing the features of the face from the biometric data 202 can be compared or matched with the one or more feature vectors of the one or more templates to determine a similarity between the feature vectors. For example, a similarity can be determined between the feature vector representing the face in the biometric data 202 and the feature vector of each template, resulting in multiple similarity values.

As noted above, the similarity score 207 can be used to make the final authentication decision. For example, the similarity score 207 can be compared 210 to a similarity threshold. In some examples, the similarity threshold can include a percentage of similarity (e.g., 75%, 80%, 85%, etc. of the features are similar). If the similarity score 207 is greater than the similarity threshold, the device is unlocked at block 212. However, if the similarity score 207 is not greater than the threshold, the device remains locked at block 214.

In some implementations, devices (e.g., mobile devices such as phones) utilizing biometric authentication may implement an unlock timeout period. An unlock timeout period is a period of inactivity on the device (when unlocked), after which the device is automatically locked and a new biometric authentication will need to be performed to unlock the device. In some examples, such devices may also implement a separate screen timeout period. A screen timeout period is a period of inactivity on the device (when the screen or display of the device is active or “on”) after which the screen or display of the device is automatically turned off (e.g., the screen or display is powered off). The device may continue to remain unlocked when the screen or display is turned off.

In some cases, the feature extraction 204, similarity computation 206, and the comparison 210 may be performed within the context of a biometrics process execution environment (BPEE) 216, which may be a process (e.g., application process, software, etc.) executing in a TEE, such as TEE 180 of FIG. 1. A process may be an executing set of instructions (e.g., software program or hardware implemented instructions). In some cases, the BPEE may be implemented using dedicated hardware, such as a digital signal processor (DSP) or other component and the process may refer to the hardware implementation of the BPEE. The BPEE may be a process which handles (e.g., processes) biometric information. In some cases, it may be useful to leverage the increased security offered by the high assurance execution environment (HAEE) of a device in addition to the TEE, for example to help ensure biometric security, such as by detecting potential attacks against components of the biometric system, such as the sensor and/or BPEE.

For example, if an attacker comprises the sensor and/or the BPEE and records biometric information acquired by the sensor between the sensor and the BPEE, the attacker may not be able to use the recorded biometric information for a replay attack on the sensor or BPEE by injecting the recorded biometric information. To prevent such replay attacks, the biometric information received by the sensor and BPEE may be cross-checked by the HAEE to ensure that the received biometric information is the same. This cross-checking may ensure a freshness of the acquired biometric data. As used herein, freshness may refer to whether the biometric information being used to authenticate (or other sensor information captured) was recently captured by the sensor, or whether the biometric information may be a replay of previously captured biometric information. Of note, while discussed in the context of a biometric system, the techniques discussed herein may be applied to any sensor system with processes and/or components executing in a trusted environment as well as a HAEE of a device

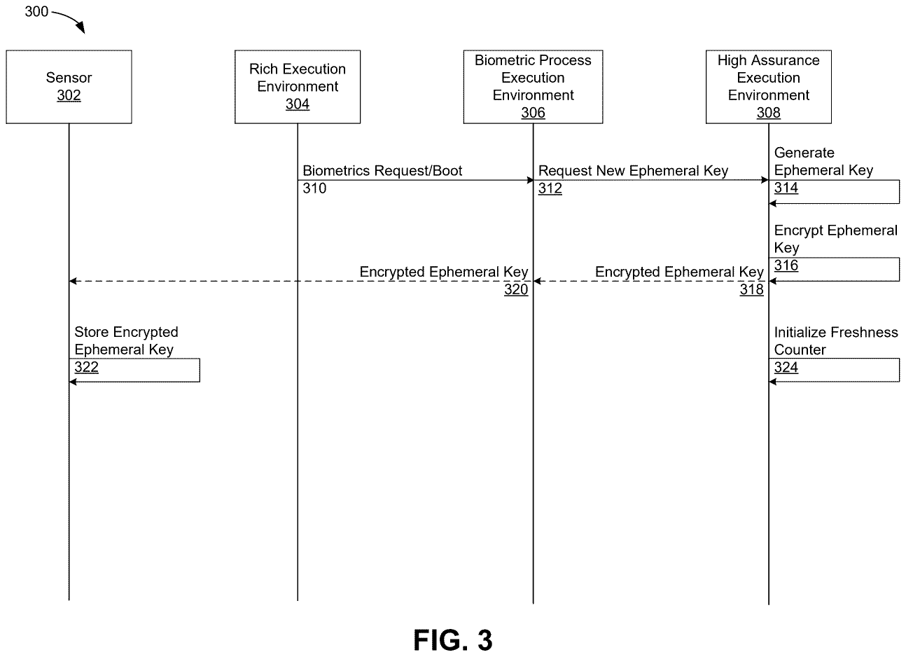

FIG. 3 is a diagram illustrating signals and operations for a secure pairing process 300 for ensuring biometric input freshness, in accordance with aspects of the present disclosure. FIG. 3 includes a sensor 302 (e.g., biometric sensor), a rich execution environment (REE) 304, a biometric process execution environment (BPEE) 306, and a high assurance execution environment (HAEE) 308. The sensor 302 may be a sensor for capturing biometric information, such as a fingerprint reader, camera, iris scanner, palm print reader, ultrasonic sensor, etc. The sensor 302 may include an integrated root of trust (RoT). The RoT may serve to anchor a chain of trust to validate other hardware and/or software. In some cases, multiple components of a device may include RoTs. For example, a TEE (e.g., TEE 180 of FIG. 1) and/or secure element (e.g., secure element 190 of FIG. 1) may serve as a RoT for a processor (e.g., processor 110 of FIG. 1), along with the RoT integrated with the sensor 302.

The REE 304 may be an untrusted execution environment of a device in which a high-level operating system (OS) of the device (e.g., Android, iOS, Windows, etc.) executes. In some cases, the REE 304 may have access to more features of the device as compared to the BPEE 306 or HAEE 308. The BPEE 306, as discussed above, may execute in a TEE (e.g., TEE 180 of FIG. 1) of the device. The HAEE 308 may execute in a secure element (e.g., secure element 190 of FIG. 1) of the device.

As a part of the secure pairing process 300, an application executed in the REE 304 may request a biometric authentication 310 be performed. For example, the application execution in the REE 304 may access an application programming interface (API) that may be used to perform biometric authentication. The secure pairing process 300 may be performed based on the request for biometric authentication 310. For example, the secure pairing process 300 may be performed for every N authentication requests. In some cases, the secure pairing process 300 may also be performed on boot of the REE 304.

The request for biometric authentication 310 may be passed to the BPEE 306. The BPEE 306 indicate to the HAEE 308 that a biometric request has been received, for example, by requesting a new ephemeral key 312. In response to the request for a new ephemeral key 312, the HAEE 308 may generate a random ephemeral key 314 (E_key). The ephemeral key may be a shared cryptographic key made up of a string of alphanumeric characters and/or symbol characters that is randomly (and/or pseudo-randomly) generated. The HAEE 308 may encrypt the ephemeral key 316 using a shared key encryption key (KEK). In some cases, the KEK may be cryptographic key that may be obtained by the HAEE 308 from the sensor 302. In some cases, the KEK may be obtained from the RoT of the sensor 302. The KEK may be obtained, for example, using a key exchange procedure of a registration process, another manufacturing process, mobile personalization process, etc., where the HAEE 308 and/or BPEE 306 are paired (e.g., registered) with the sensor 302 (and/or vice versa).

In some cases, the HAEE 308 may initialize a freshness counter 324 or reset the freshness counter. The freshness counter may be a counter that tracks a number of biometric authentication requests that have been performed. For example, the freshness counter may track the number of biometric authentication requests that have been performed. When the freshness counter reaches N, the secure pairing process 300 may be triggered. The freshness counter may then be reinitialized (e.g., reset).

The HAEE 308 may then return the encrypted ephemeral key 318 to the BPEE 306. The BPEE 306 may send the encrypted ephemeral key 320 to the sensor 302. In some cases, the sensor 302 may store the encrypted ephemeral key 322, for example, for use as a part of acquiring biometric information. In some cases, the encrypted ephemeral key may be stored in the RoT of the sensor 302.

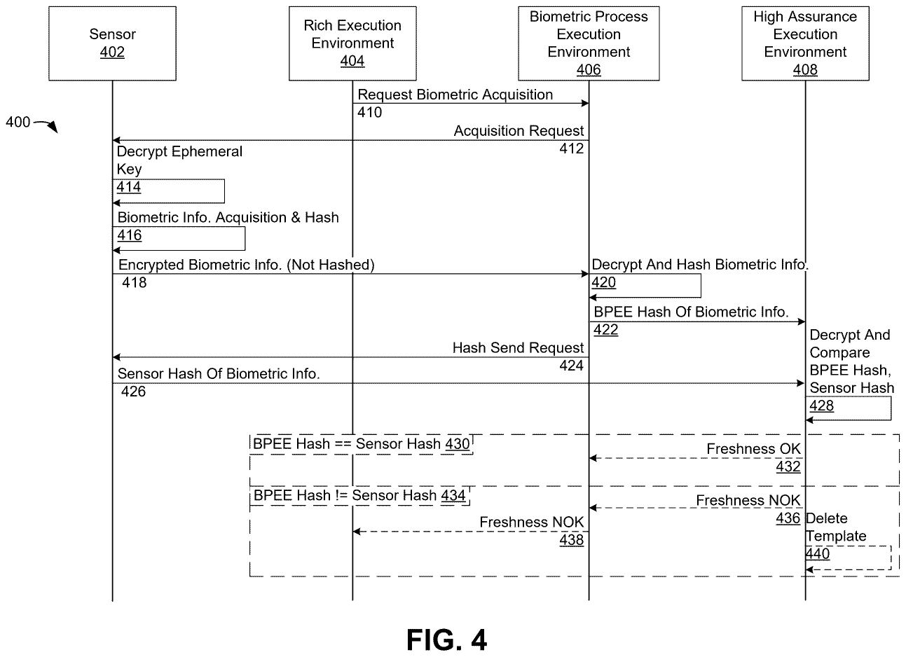

FIG. 4 is a diagram illustrating signals and operations for an acquisition request process 400 for ensuring biometric input freshness, in accordance with aspects of the present disclosure. As in FIG. 3, FIG. 4 includes a sensor 402, an REE 404, a BPEE 406, and a HAEE 408. The sensor 402, REE 404, BPEE 406, and HAEE 408 may be substantially similar to sensor 302, REE 304, BPEE 306, and HAEE 308 of FIG. 3, respectively. In some cases, the acquisition request process 400 may use an established secure channel between the sensor 402 (e.g., a RoT of sensor 402) HAEE 408, and BPEE 406. In some cases, the secure channel may be established by determining and exchanging a session key via the HAEE 408 that may be used to encrypt messages between the sensor 402 and the BPEE 406 such that the sensor 402, BPEE 406, and HAEE 408 have a copy of the session key of use with the secure channel. In some cases, asymmetric cryptographic schemes (e.g., public/private keys) may also be used to establish the session key. While the secure channel may be established to provide confidentiality of the biometric information, the secure channel may be optional with respect to verifying biometric input freshness.

In some cases, as a part of the acquisition request process 400, the REE 404 may send a request to acquire biometric information 410 (e.g., authentication request, sensor request, request to obtain sensor information, etc.) to the BPEE 406. For example, an application executing in the REE 404 may access an API to request biometric information be acquired from a user. The BPEE 406 may send an acquisition request 412 to the sensor 402. In response to the acquisition request 412, the sensor 402 may decrypt the stored ephemeral key 414, for example, using the KEK shared with the HAEE 408 to obtain a decrypted ephemeral key. In some cases, the stored ephemeral key 414 may be decrypted before, concurrent to, or after the biometric information 416 is acquired. The sensor 402 may then acquire biometric information 416, for example, from the user. For example, the sensor 402 may initiate, in response to the acquisition request 412, may sample an environment around the sensor to obtain biometric information (e.g., an image, fingerprint, ultrasonic scan information, infrared data, etc.) from the user. The biometric information may be hashed to obtain a sensor hash of the biometric information. Any hash function may be used for hashing the biometric information, examples of which may include secure hash function (SHA) 2, SHA-3, etc. The sensor 402 may temporarily store the sensor hash of the biometric information.

The sensor 402 may also encrypt the acquired non-hashed biometric information using the session key shared with the BPEE 406 to obtain encrypted biometric information. The encrypted biometric information may be sent by the sensor 402 to the BPEE 406. The BPEE 406 may receive the encrypted biometric information and decrypt the encrypted biometric information using the shared session key to obtain the biometric information. The BPEE 406 may hash 420 the biometric information to obtain a BPEE hash of the biometric information. The BPEE 406 may encrypt the BPEE hash of the biometric information using the session key and send the encrypted BPEE hash 422 to the HAEE 408.

The BPEE 406 may also send the sensor 402 an indication (e.g., request, command, etc.) to send the sensor hash 424 of the biometric information to the HAEE 408. In response, the sensor 402 may encrypt the stored sensor hash using, for example, the ephemeral key and the session key. The sensor 402 may send the encrypted sensor hash 426 of the biometric information to the HAEE 408. The HAEE 408 may decrypt the encrypted BPEE hash and the encrypted sensor hash and compare 428 the BPEE hash and the sensor hash. If the BPEE hash and the sensor hash match 430, the HAEE 408 may send an indication that the match was successful 432 (e.g., OK) and authentication of the biometric information may proceed as normal. For example, the BPEE may attempt to authenticate the biometric information against one or more stored templates.

The BPEE hash not matching with the sensor hash 434 may be an indication that either the BPEE 406 and/or the sensor 402 has been compromised and may be under attack. In such cases, the HAEE 408 may send an indication, such as a NOK 436, to the BPEE 406 that the match was not successful. The BPEE 406 may then indicate to the REE that the match was not successful (e.g., NOK) 438. In some cases, as the BPEE 406 and/or the sensor 402 may be compromised, the HAEE 408 may also delete 440 stored templates for the biometrics, the ephemeral key, etc. A new enrollment procedure may be performed to establish new templates for use with biometrics.

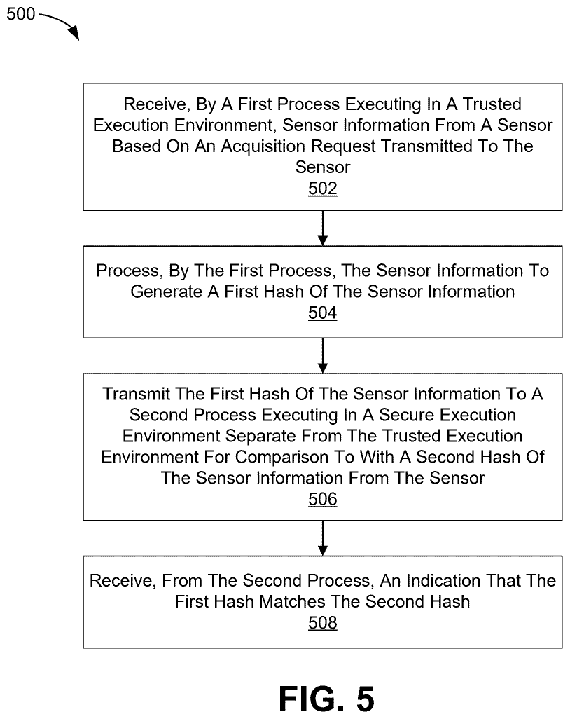

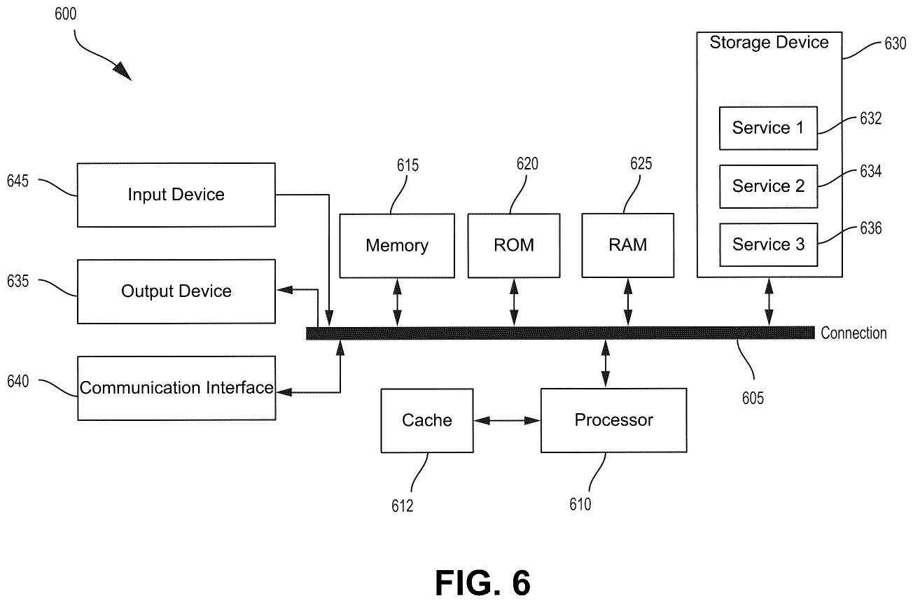

FIG. 5 is a flow diagram of a process 500 for biometric security, in accordance with aspects of the present disclosure. The process 500 may be performed by a computing device (or apparatus) or a component (e.g., a chipset, codec, processor 110 of FIG. 1, TEE 180 of FIG. 1, secure element 190 of FIG. 1, processor 610 of FIG. 6, etc.) of the computing device. Examples of the computing device can include the wireless device 100 of FIG. 1, computing system 600 of FIG. 6. The computing device may be a mobile device (e.g., a mobile phone), an extended reality (XR) device such as a virtual reality (VR) device or augmented reality (AR) device, a vehicle or component or system of a vehicle, a network-connected wearable such as a watch, or other type of computing device. In another example, the process 500 may be performed by a computing device with the computing system 600 shown in FIG. 6. The operations of the process 500 may be implemented as software components that are executed and run on one or more processors. In some cases, the computing device may include an indication, such as a configuration, that the UE may use an enhanced privacy technique, such as techniques discussed in accordance with aspects of the present disclosure.

At block 502, the computing device (or component thereof) may receive, using a first process (e.g., BPEE 406 of FIG. 4) executing in a trusted execution environment (e.g., TEE 180 of FIG. 1), sensor information from a sensor (e.g., sensor 160 of FIG. 1, sensor 402 of FIG. 4) based on an acquisition request transmitted (e.g., acquisition request 412 of FIG. 4) to the sensor. For example, the BPEE may send an acquisition request to the sensor. The sensor may, in response to the acquisition request, acquire sensor information and send the sensor information to the BPEE. In some aspects, the sensor information may be hashed. In some cases, the computing device (or component thereof) may includes a sensor. In some examples, the sensor comprises a biometric sensor, and the sensor information comprises biometric information. In some cases, the computing device (or component thereof) may match (e.g., similarity computation 206 of FIG. 2) the biometric information against a stored template (e.g., in template storage 208 of FIG. 2) based on the indication that the first hash matches the second hash.

At block 504, the computing device (or component thereof) may process, using the first process, the sensor information to generate a first hash (e.g., hash 420 of FIG. 4) of the sensor information. For example, the BPEE may hash the biometric information to obtain a BPEE hash of the biometric information. In some cases, computing device (or component thereof) may transmit, to the sensor, a request to send the second hash (e.g., indication to send the sensor hash 424 of FIG. 4). In some aspects, the second hash is sent (e.g., send the encrypted sensor hash 426 of FIG. 4) to the second process in response to the request to send the second hash.

At block 506, the computing device (or component thereof) may transmit the first hash of the sensor information (e.g., send the encrypted BPEE hash 422 of FIG. 4) to a second process executing in a secure execution environment separate (e.g., secure element 190 of FIG. 1, BPEE 406 of FIG. 6) from the trusted execution environment for comparison (e.g., compare 428 of FIG. 4) with a second hash (e.g., sensor hash 424 of FIG. 4) of the sensor information from the sensor. For example, the HAEE may decrypt the encrypted BPEE hash and the encrypted sensor hash and compare the BPEE hash and the sensor hash. In some cases, the second hash of the sensor information from the sensor is encrypted based on an ephemeral key shared between the sensor and the second process. In some aspects, the computing device (or component thereof) may receive a sensor request (e.g., request for biometric authentication 310 of FIG. 3) to obtain sensor information. The computing device (or component thereof) may transmit, to the second process, a request for the ephemeral key (e.g., request for a new ephemeral key 312 of FIG. 3) in response to the sensor request. The computing device (or component thereof) may receive, from the second process, an encrypted ephemeral key (e.g., encrypted ephemeral key 318 of FIG. 3) and may transmit, to the sensor, the encrypted ephemeral key (e.g., send the encrypted ephemeral key 320 of FIG. 3 to the sensor 302 of FIG. 3).

At block 508, the computing device (or component thereof) may receive, from the second process, an indication that the first hash matches the second hash (e.g., successful 432 of FIG. 4). In some cases, the computing device (or component thereof) may process the sensor information to authenticate a user based on the received indication that the first hash matches the second hash. For example, based on an indication that the match was successful 432 of FIG. 4 (e.g., OK) the authentication of the biometric information may proceed as normal. In some aspects, the computing device (or component thereof) may receive, using the first process, second sensor information from the sensor. The computing device (or component thereof) may process, by the first process, the second sensor information to generate a third hash of the sensor information. In some cases, the third hash may be generated in a manner substantially similar to the first hash (resulting in the third hash having a same hash value as the first hash), but generated/used at a different time as compared to the first hash. The computing device (or component thereof) may transmit the third hash of the sensor information to the second process for comparison with a fourth hash of the second sensor information from the sensor. In some cases, the fourth hash may be generated in a manner substantially similar to the second hash (resulting in the fourth hash having a same hash value as the second hash), but generated/used at a different time as compared to the second hash. The computing device (or component thereof) may receive an indication that the third hash is different (e.g., NOK 436) from the fourth hash. In some cases, the computing device (or component thereof) may delete a biometric template based on the indication that the third hash is different from the fourth hash. For example, the HAEE may delete 440 of FIG. 4 stored templates for the biometrics. In some cases, the computing device (or component thereof) may perform an enrollment procedure based on the indication that the third hash is different from the fourth hash. For example, a new enrollment procedure may be performed to establish new templates for use with biometrics based on the indication that the third hash does not match the fourth hash.

In some examples, the techniques or processes described herein may be performed by a computing device, an apparatus, and/or any other computing device. In some cases, the computing device or apparatus may include a processor, microprocessor, microcomputer, or other component of a device that is configured to carry out the steps of processes described herein. In some examples, the computing device or apparatus may include a camera configured to capture video data (e.g., a video sequence) including video frames. For example, the computing device may include a camera device, which may or may not include a video codec. As another example, the computing device may include a mobile device with a camera (e.g., a camera device such as a digital camera, an IP camera or the like, a mobile phone or tablet including a camera, or other type of device with a camera). In some cases, the computing device may include a display for displaying images. In some examples, a camera or other capture device that captures the video data is separate from the computing device, in which case the computing device receives the captured video data. The computing device may further include a network interface, transceiver, and/or transmitter configured to communicate the video data. The network interface, transceiver, and/or transmitter may be configured to communicate Internet Protocol (IP) based data or other network data.

The processes described herein can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

In some cases, the devices or apparatuses configured to perform the operations of the process 500 and/or other processes described herein may include a processor, microprocessor, micro-computer, or other component of a device that is configured to carry out the steps of the process 500 and/or other process. In some examples, such devices or apparatuses may include one or more sensors configured to capture image data and/or other sensor measurements. In some examples, such computing device or apparatus may include one or more sensors and/or a camera configured to capture one or more images or videos. In some cases, such device or apparatus may include a display for displaying images. In some examples, the one or more sensors and/or camera are separate from the device or apparatus, in which case the device or apparatus receives the sensed data. Such device or apparatus may further include a network interface configured to communicate data.

The components of the device or apparatus configured to carry out one or more operations of the process 500 and/or other processes described herein can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The process 500 is illustrated as a logical flow diagram, the operations of which represent sequences of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the processes described herein (e.g., the process 500 and/or other processes) may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program including a plurality of instructions executable by one or more processors. The computer-readable or machine-readable storage medium may be non-transitory.

Additionally, the processes described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 6 is a diagram illustrating an example of a system for implementing certain aspects of the present technology. In particular, FIG. 6 illustrates an example of computing system 600, which may be for example any computing device making up internal computing system, a remote computing system, a camera, or any component thereof in which the components of the system are in communication with each other using connection 605. Connection 605 may be a physical connection using a bus, or a signal connection into processor 610, such as in a chipset architecture. Connection 605 may also be a virtual connection, networked connection, or logical connection.

In some embodiments, computing system 600 is a distributed system in which the functions described in this disclosure may be distributed within a datacenter, multiple data centers, a peer network, etc. In some embodiments, one or more of the described system components represents many such components each performing some or all of the function for which the component is described. In some embodiments, the components may be physical or virtual devices.

Example system 600 includes at least one processing unit (CPU or processor) 610 and connection 605 that communicatively couples various system components including system memory 615, such as read-only memory (ROM) 620 and random access memory (RAM) 625 to processor 610. Computing system 600 may include a cache 612 of high-speed memory connected directly with, in close proximity to, or integrated as part of processor 610.

Processor 610 may include any general purpose processor and a hardware service or software service, such as services 632, 634, and 636 stored in storage device 630, configured to control processor 610 as well as a special-purpose processor where software instructions are incorporated into the actual processor design. Processor 610 may essentially be a completely self-contained computing system, containing multiple cores or processors, a bus, memory controller, cache, etc. A multi-core processor may be symmetric or asymmetric.

To enable user interaction, computing system 600 includes an input device 645, which may represent any number of input mechanisms, such as a microphone for speech, a touch-sensitive screen for gesture or graphical input, keyboard, mouse, motion input, speech, etc. Computing system 600 may also include output device 635, which may be one or more of a number of output mechanisms. In some instances, multimodal systems may enable a user to provide multiple types of input/output to communicate with computing system 600.

Computing system 600 may include communications interface 640, which may generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 640 may also include one or more Global Navigation Satellite System (GNSS) receivers or transceivers that are used to determine a location of the computing system 600 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 630 may be one or more non-volatile and/or non-transitory and/or computer-readable memory devices and may be a hard disk or other types of computer readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 630 may include software services, servers, services, etc., that when the code that defines such software is executed by the processor 610, it causes the system to perform a function. In some embodiments, a hardware service that performs a particular function may include the software component stored in a computer-readable medium in connection with the necessary hardware components, such as processor 610, connection 605, output device 635, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the embodiments and examples provided herein, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual embodiments may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general purpose computer, special purpose computer, or a processing device to perform a certain function or group of functions. Portions of computer resources used may be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some embodiments the computer-readable storage devices, mediums, and memories may include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed by one or more processors, performs one or more of the methods, algorithms, and/or operations described above. The computer-readable data storage medium may form part of a computer program product, which may include packaging materials. The computer-readable medium and/or memory system may comprise any memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, memory 615, read-only memory (ROM) 620, random access memory (RAM) 625, storage device 630, and the like, and the computer-readable medium may include multiple memories or data storage media. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor system, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor system may be configured to perform any of the techniques described in this disclosure. A general-purpose processor may be a microprocessor; but in the alternative, the processor may be any conventional processor, controller, microcontroller, or state machine. A processor system may also be implemented as a combination of computing devices, e.g., a combination of a DSP and a microprocessor, a plurality of microprocessors, one or more microprocessors in conjunction with a DSP core, or any other such configuration. Accordingly, the term “processor system,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein may be replaced with less than or equal to (“≤”) and greater than or equal to (“≥”) symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

Illustrative aspects of the disclosure include:

Aspect 1. An apparatus for security, comprising: a memory system comprising instructions; and a processor system coupled to the memory system, wherein the processor system is configured to: receive, by a first process executing in a trusted execution environment, sensor information from a sensor based on an acquisition request transmitted to the sensor; process, by the first process, the sensor information to generate a first hash of the sensor information; transmit the first hash of the sensor information to a second process executing in a secure execution environment separate from the trusted execution environment for comparison with a second hash of the sensor information from the sensor; and receive, from the second process, an indication that the first hash matches the second hash.

Aspect 2. The apparatus of Aspect 1, wherein the sensor comprises a biometric sensor, wherein the sensor information comprises biometric information, and wherein the processor system is further configured to match the biometric information against a stored template based on the indication that the first hash matches the second hash.

Aspect 3. The apparatus of any of Aspects 1-2, wherein the second hash of the sensor information from the sensor is encrypted based on an ephemeral key shared between the sensor and the second process.

Aspect 4. The apparatus of Aspect 3, wherein the processor system is further configured to: receive a sensor request to obtain sensor information; transmit, to the second process, a request for the ephemeral key in response to the sensor request; receive, from the second process, an encrypted ephemeral key; and transmit, to the sensor, the encrypted ephemeral key.

Aspect 5. The apparatus of any of Aspects 1-4, wherein the processor system is further configured to transmit, to the sensor, a request to send the second hash, and wherein the second hash is sent to the second process in response to the request to send the second hash.

Aspect 6. The apparatus of any of Aspects 1-5, wherein the processor system is further configured to: receive, by the first process, second sensor information from the sensor; process, by the first process, the second sensor information to generate a third hash of the sensor information; transmit the third hash of the sensor information to the second process for comparison with a fourth hash of the second sensor information from the sensor; and receive an indication that the third hash is different from the fourth hash.

Aspect 7. The apparatus of Aspect 6, wherein the processor system is configured to delete a biometric template based on the indication that the third hash is different from the fourth hash.

Aspect 8. The apparatus of any of Aspects 6-7, wherein the processor system is configured to perform an enrollment procedure based on the indication that the third hash is different from the fourth hash.

Aspect 9. The apparatus of any of Aspects 1-8, wherein the processor system is further configured to process the sensor information to authenticate a user based on the received indication that the first hash matches the second hash.

Aspect 10. A method for security, comprising: receiving, by a first process executing in a trusted execution environment, sensor information from a sensor based on an acquisition request transmitted to the sensor; processing, by the first process, the sensor information to generate a first hash of the sensor information; transmitting the first hash of the sensor information to a second process executing in a secure execution environment separate from the trusted execution environment for comparison with a second hash of the sensor information from the sensor; and receiving, from the second process, an indication that the first hash matches the second hash.

Aspect 11. The method of Aspect 10, wherein the sensor comprises a biometric sensor, wherein the sensor information comprises biometric information, and further comprising matching the biometric information against a stored template based on the indication that the first hash matches the second hash.

Aspect 12. The method of any of Aspects 10-11, wherein the second hash of the sensor information from the sensor is encrypted based on an ephemeral key shared between the sensor and the second process.

Aspect 13. The method of Aspect 12, further comprising: receiving a sensor request to obtain sensor information; transmitting, to the second process, a request for the ephemeral key in response to the sensor request; receiving, from the second process, an encrypted ephemeral key; and transmitting, to the sensor, the encrypted ephemeral key.

Aspect 14. The method of any of Aspects 10-13, further comprising transmitting, to the sensor, a request to send the second hash, and wherein the second hash is sent to the second process in response to the request to send the second hash.

Aspect 15. The method of any of Aspects 10-14, further comprising: receiving, by the first process, second sensor information from the sensor; processing, by the first process, the second sensor information to generate a third hash of the sensor information; transmitting the third hash of the sensor information to the second process for comparison with a fourth hash of the second sensor information from the sensor; and receiving an indication that the third hash is different from the fourth hash.

Aspect 16. The method of Aspect 15, further comprising deleting a biometric template based on the indication that the third hash is different from the fourth hash.

Aspect 17. The method of any of Aspects 15-16, further comprising performing an enrollment procedure based on the indication that the third hash is different from the fourth hash.

Aspect 18. The method of any of Aspects 10-17, further comprising processing the sensor information to authenticate a user based on the received indication that the first hash matches the second hash.

Aspect 19. A non-transitory computer-readable medium having stored thereon instructions that, when executed by at least one processor, cause the at least one processor to: receive, by a first process executing in a trusted execution environment, sensor information from a sensor based on an acquisition request transmitted to the sensor; process, by the first process, the sensor information to generate a first hash of the sensor information; transmit the first hash of the sensor information to a second process executing in a secure execution environment separate from the trusted execution environment for comparison with a second hash of the sensor information from the sensor; and receive, from the second process, an indication that the first hash matches the second hash.

Aspect 20. The non-transitory computer-readable medium of Aspect 19, wherein the sensor comprises a biometric sensor, wherein the sensor information comprises biometric information, and wherein the instructions further cause the at least one processor to match the biometric information against a stored template based on the indication that the first hash matches the second hash.

Aspect 21. A non-transitory computer-readable medium having stored thereon instructions that, when executed by at least one processor, cause the at least one processor to perform operations according to any of Aspects 10-18.

Aspect 22. An apparatus for security, comprising one or more means for performing operations according to any of Aspects 10-18.

What is claimed is:

1. An apparatus for security, comprising:
a memory system comprising instructions; and
a processor system coupled to the memory system, wherein the processor system is configured to:
receive, by a first process executing in a trusted execution environment, sensor information from a sensor based on an acquisition request transmitted to the sensor;
process, by the first process, the sensor information to generate a first hash of the sensor information;
transmit the first hash of the sensor information to a second process executing in a secure execution environment separate from the trusted execution environment for comparison with a second hash of the sensor information from the sensor; and
receive, from the second process, an indication that the first hash matches the second hash.

2. The apparatus of claim 1, wherein the sensor comprises a biometric sensor, wherein the sensor information comprises biometric information, and wherein the processor system is further configured to match the biometric information against a stored template based on the indication that the first hash matches the second hash.

3. The apparatus of claim 1, wherein the second hash of the sensor information from the sensor is encrypted based on an ephemeral key shared between the sensor and the second process.

4. The apparatus of claim 3, wherein the processor system is further configured to:
receive a sensor request to obtain sensor information;
transmit, to the second process, a request for the ephemeral key in response to the sensor request;
receive, from the second process, an encrypted ephemeral key; and
transmit, to the sensor, the encrypted ephemeral key.

5. The apparatus of claim 1, wherein the processor system is further configured to transmit, to the sensor, a request to send the second hash, and wherein the second hash is sent to the second process in response to the request to send the second hash.

6. The apparatus of claim 1, wherein the processor system is further configured to:
receive, by the first process, second sensor information from the sensor;
process, by the first process, the second sensor information to generate a third hash of the sensor information;
transmit the third hash of the sensor information to the second process for comparison with a fourth hash of the second sensor information from the sensor; and
receive an indication that the third hash is different from the fourth hash.

7. The apparatus of claim 6, wherein the processor system is configured to delete a biometric template based on the indication that the third hash is different from the fourth hash.

8. The apparatus of claim 6, wherein the processor system is configured to perform an enrollment procedure based on the indication that the third hash is different from the fourth hash.

9. The apparatus of claim 1, wherein the processor system is further configured to process the sensor information to authenticate a user based on the received indication that the first hash matches the second hash.

10. A method for security, comprising:
receiving, by a first process executing in a trusted execution environment, sensor information from a sensor based on an acquisition request transmitted to the sensor;
processing, by the first process, the sensor information to generate a first hash of the sensor information;
transmitting the first hash of the sensor information to a second process executing in a secure execution environment separate from the trusted execution environment for comparison with a second hash of the sensor information from the sensor; and
receiving, from the second process, an indication that the first hash matches the second hash.

11. The method of claim 10, wherein the sensor comprises a biometric sensor, wherein the sensor information comprises biometric information, and further comprising matching the biometric information against a stored template based on the indication that the first hash matches the second hash.

12. The method of claim 10, wherein the second hash of the sensor information from the sensor is encrypted based on an ephemeral key shared between the sensor and the second process.

13. The method of claim 12, further comprising:
receiving a sensor request to obtain sensor information;
transmitting, to the second process, a request for the ephemeral key in response to the sensor request;
receiving, from the second process, an encrypted ephemeral key; and
transmitting, to the sensor, the encrypted ephemeral key.

14. The method of claim 10, further comprising transmitting, to the sensor, a request to send the second hash, and wherein the second hash is sent to the second process in response to the request to send the second hash.

15. The method of claim 10, further comprising:
receiving, by the first process, second sensor information from the sensor;
processing, by the first process, the second sensor information to generate a third hash of the sensor information;
transmitting the third hash of the sensor information to the second process for comparison with a fourth hash of the second sensor information from the sensor; and
receiving an indication that the third hash is different from the fourth hash.

16. The method of claim 15, further comprising deleting a biometric template based on the indication that the third hash is different from the fourth hash.

17. The method of claim 15, further comprising performing an enrollment procedure based on the indication that the third hash is different from the fourth hash.

18. The method of claim 10, further comprising processing the sensor information to authenticate a user based on the received indication that the first hash matches the second hash.

19. A non-transitory computer-readable medium having stored thereon instructions that, when executed by at least one processor, cause the at least one processor to:
receive, by a first process executing in a trusted execution environment, sensor information from a sensor based on an acquisition request transmitted to the sensor;
process, by the first process, the sensor information to generate a first hash of the sensor information;
transmit the first hash of the sensor information to a second process executing in a secure execution environment separate from the trusted execution environment for comparison with a second hash of the sensor information from the sensor; and
receive, from the second process, an indication that the first hash matches the second hash.

20. The non-transitory computer-readable medium of claim 19, wherein the sensor comprises a biometric sensor, wherein the sensor information comprises biometric information, and wherein the instructions further cause the at least one processor to match the biometric information against a stored template based on the indication that the first hash matches the second hash.
